(19) United States
(12) Patent Application Publication
(10) Pub. No.: US 2022/0276346 A1
(43) Pub. Date: Sep. 1, 2022

(54) RECEIVING UNIT FOR A LIDAR DEVICE

(71) Applicant: Robert Bosch GmbH, Stuttgart (DE)

(72) Inventor: Alexander Greiner, Reichenbach (DE)

(21) Appl. No.: 17/631,410

(22) PCT Filed: Aug. 3, 2020
(86) PCT No.: PCT/EP2020/071788

§ 371 Date: Jan. 28, 2022

(30) Foreign Application Priority Data
Aug. 22, 2019 (DE) 10 2019 212 611.1

(51) Int. Cl. G01S 7/481; G02B 5/00; G02B 27/42

(52) U.S. Cl. CPC G01S 7/4816; G01S 7/4814; G02B 5/005; G02B 27/4244

(57) ABSTRACT

A receiving unit, in particular for a LIDAR device, for receiving rays reflected and/or backscattered from an object. The receiving unit includes receiving optics and at least one detector, wherein arranged in a ray path of the rays between the receiving optics and the detector are a directional filter and a wavelength-selective unit. A LIDAR device and a method for evaluating measurement data of a detector are described.

### FIELD

The present invention relates to a receiving unit, in particular for a LIDAR device, for receiving rays reflected and/or backscattered from an object, including receiving optics and at least one detector. The present invention further relates to a LIDAR device.

### BACKGROUND INFORMATION

LIDAR devices are gaining increasingly in importance due to the trend towards more automation in various technical fields, such as for example the automotive sector. Currently, only mechanical laser scanners are available for covering large horizontal sampling angles between 150° and 360°.

LIDAR devices manifested as rotating mirror laser scanners are available, whose highest horizontal sampling range is limited to ca. 150°. In such a LIDAR device, only a motor-driven deflecting mirror rotates whereas the transmitting unit and the receiving unit are arranged as stationary relative to the deflecting mirror.

To implement larger horizontal sampling ranges of up to 360°, the transmitting unit and the receiving unit are arranged on a motor-driven turntable or rotor.

Bandpass filters are commonly used in the receiving unit for filtering out spurious reflections and for increasing the signal-to-noise ratio. The realization of narrow-band bandpass filters for suppressing the extraneous light can, however, be problematic, since the wavelength of the received rays can differ from a wavelength of the emitted rays. Consequently, it is possible that the signal-to-noise ratio is reduced and the range of the LIDAR device restricted.

### SUMMARY

An object of the present invention includes providing a receiving unit and a LIDAR device which make it possible to adapt the wavelength range to a wavelength range of rays generated in a transmitting unit.

This object may be achieved by the present invention. Advantageous developments of the present invention are disclosed herein.

According to one aspect of the present invention, there is provided a receiving unit, in particular for a LIDAR device. The receiving unit serves for receiving rays, reflected and/or backscattered from an object, which previously were emitted from a transmitting unit into the sampling region. In accordance with an example embodiment of the present invention, the receiving unit includes receiving optics and at least one detector, wherein a directional filter and a wavelength-selective unit are arranged in a ray path of the rays between the receiving optics and the detector.

According to a further aspect of the present invention, a LIDAR device is provided for the sampling of sampling regions. In accordance with an example embodiment of the present invention, the LIDAR device includes at least one transmitting unit for generating and emitting generated rays into a sampling region and at least one receiving unit according to the present invention for receiving and evaluating rays backscattered and/or reflected from the sampling region.

Such a LIDAR device may for example be utilized in the automotive sector, in aviation, in metrology, and the like. Planar detectors may in particular be used as detectors of the receiving unit. The at least one detector may for example be implemented as a CCD, as a CMOS, or as a SPAD array.

The rays backscattered and/or reflected from the sampling region are received by the receiving unit. For this purpose there may be provided receiving optics which may guide the rays incoming from the sampling region directly or indirectly onto the directional filter.

The directional filter forms a first region of the receiving unit and allows filtering of the received rays according to their direction of incidence onto the receiving unit. Hereby, only those received rays may be transmitted which arrive in the receiving unit from a predefined direction. The predefined direction may for example be determined in a LIDAR device by a relative orientation of the transmitting unit and the receiving unit and a resulting angle of reflection at a plane surface. Consequently, spurious light from the environment of the receiving unit may be blocked and/or filtered respectively in the first region of the receiving unit. Preferably, only rays generated by the transmitting unit and subsequently reflected and/or backscattered respectively may pass the directional filter.

The wavelength-selective unit forms a second region of the receiving unit. In accordance with an example embodiment of the present invention, the wavelength-selective unit may preferably split up rays according to their wavelength rays transmitted through the directional filter. To this end, the rays incident on the wavelength-selective unit are deflected to different extents as a function of their wavelength. This results in the rays being incident on different places on the detector, depending on their wavelength. Consequently, by way of the two regions of the receiving unit, multistage filtering of the rays may be realized. Through a location-dependent selection of measurement data of the detector, a wavelength-dependent evaluation of the measurement data may be performed. In particular, by selecting measurement data from a correct region of the detector, spurious background light may be separated from a useful signal. Consequently, depending on the configuration of the receiving unit, one or several regions of the detector may be selected for a further evaluation of measurement data.

The regions of the detector may be configured as square, linear, circular, and the like. In particular, the regions may include one or several pixels. The detector may be linkable with an evaluation unit, which for example may assign wavelengths to light-sensitive regions of the detector based on the properties of the wavelength-selective unit. The evaluation unit may in this connection receive all the measurement data of the detector and subsequently filter them and/or use them for a further evaluation respectively or receive only measurement data from one light-sensitive region of the detector. The further evaluation of the measurement data may for example comprise implementation of a time-of-flight method.

Using the receiving unit, a wavelength range relevant for the evaluation may be selected and/or adapted respectively to a wavelength range of the rays generated by the transmitting unit. Using this measure, a bandwidth of the receiving unit may be decreased and the signal-to-noise ratio improved. The reduced bandwidth makes it possible to block background light emitted in the direction of the receiving unit.

According to an advantageous embodiment of the present invention, the at least one region of the detector used for the evaluation may be selected in an automated or variable manner. Automated adaptation of a bandwidth and of the wavelength range of the receiving unit may hereby be realized.

According to a further example embodiment of the present invention, the directional filter is implemented as a diaphragm or as a slit diaphragm. Hereby, rays reflected and/or backscattered from the sampling region may be allowed through from a particular horizontal and vertical angular range in a technically simple and efficient manner. In particular, rays from different sources than the transmitting unit may be especially simply suppressed through the use of the directional filter.

According to a further example embodiment of the present invention, the wavelength-selective unit exhibits transmitting or reflecting wavelength selectivity. The receiving unit may consequently be constructed especially flexibly. Depending on a form and size of the receiving unit, the wavelength-selective unit is able to transmit or reflect the incoming rays. The wavelength-selective unit may hereby act wavelength-specifically on the incoming rays in the passage direction or in a reflecting manner.

According to a further example embodiment, a wavelength-dependent angle of refraction or wavelength-dependent angle of reflection is adjustable for incoming rays via the wavelength-selective unit. Hereby, with a wavelength-selective unit acting in the passage direction, the incoming rays may be refracted to different extents as a function of their wavelength. In the case of a wavelength-selective unit acting in a reflecting manner, splitting of the incoming rays may be implemented using a wavelength-specific angle of reflection.

According to a further specific embodiment of the present invention, the rays affected by the wavelength-selective unit can be guided to the detector at a wavelength-dependent angle of refraction or at a wavelength-dependent angle of reflection. Preferably, measurement values ascertained by the detector from received rays are usable for an evaluation as a function of their detection location on the detector. A spatial resolution of the detector may hereby be used for an angle-dependent resolution of the received rays. Based on such a wavelength-dependent splitting of the rays, only those measurement data may be used for an evaluation which result from rays having a defined wavelength. This makes it possible to adapt a bandwidth of the receiving unit for example in an automated manner. In particular, the measurement data may be chosen selectively for the evaluation according to a required wavelength.

According to a further specific embodiment of the present invention, the wavelength-selective unit is configured as a diffractive optical element. For example, the wavelength-selective unit may be implemented as a holographic grating or as a volume holographic grating. Such a wavelength-selective unit may be produced in a technically simple manner and include additional functions, such as for example filtering functions.

According to a further specific embodiment of the present invention, there is arranged in the ray path between the directional filter and the wavelength-selective unit at least one first optical element implemented as a lens, cylindrical lens, or lens array for collimating rays which pass the directional filter. After passing the directional filter, the rays may be optimally aligned by the first optical element towards the wavelength-selective unit. The first optical element may be configured in a flexible manner, depending on the configuration of the receiving unit.

According to an additional or alternative embodiment of the present invention, the first optical element may include one or several cylindrical lenses. For example, a cylindrical lens may be arranged before the directional filter and focus the received rays onto the directional filter, which for example is a slit diaphragm. Via a further cylindrical lens, the directionally-filtered rays may be guided onto the wavelength-selective unit and subsequently concentrated by further optics onto light-sensitive regions of the detector.

According to a further example embodiment of the present invention, at least one second optical unit is arranged in the ray path between the wavelength-selective unit and the detector. The wavelength-dependently split up rays may hereby be focused in such a way that light-sensitive regions of the detector are situated at the focal point of the second optical unit. In particular, the measurement values resulting from rays having different wavelengths may hereby be especially distinctly demarcated from one another for the evaluation.

According to a further specific embodiment of the present invention, between the wavelength-selective unit and the detector there is arranged a second optical element configured as a microlens array. Using this measure, an especially space-saving configuration of the receiving unit may be provided. Directly behind the directional filter there may be configured a plane consisting of microlenses. Directly behind the microlens plane there is preferably arranged the wavelength-selective unit. The wavelength-selective unit may have a further microlens plane and/or microlens array respectively arranged behind it in order to guide the rays onto the detector.

According to a further specific embodiment of the present invention, the directional filter, the first optical element, the wavelength-selective unit, the second optical element, and the detector are implemented in one piece or connected integrally with one another. The receiving unit may hereby be configured especially compactly. The respective components of the receiving unit may for example be connected with one another by a frame or by an adhesive.

According to a further aspect of the present invention, there is provided a method for evaluating measurement data of a detector of a receiving unit. In accordance with an example embodiment of the present invention, in one step, rays from a sampling region are received by the receiving unit and filtered by a directional filter. The filtered rays are guided directly or via at least one first optical element onto a wavelength-selective unit. The filtered rays are subsequently split up wavelength-dependently by the wavelength-selective unit and radiated wavelength-dependently onto different light-sensitive regions of the detector. The split up rays may moreover be focused or deflected by at least one second optical element before they are incident on the detector.

An option of distributing the optical power across several light-sensitive regions of the detector, such as for example one or several pixels, may hereby be realized. The rays may be distributed according to their wavelength along an available light-sensitive detector area, such that restricting the evaluation to particular wavelengths based on a location-dependent evaluation of the measurement values of the detector is possible.

According to a specific embodiment of the present invention, measurement data are generated by illuminating the light-sensitive regions of the detector and received by an evaluation unit, wherein at least one light-sensitive region of the detector is selected in an automated or predefined manner for receiving measurement data for an evaluation by the evaluation unit. The at least one region of the detector used for the evaluation may hereby be selected in an automated or variable manner. Moreover, an automated adaptation of a bandwidth and of the wavelength range of the receiving unit may be realized.

Preferred example embodiments of the present invention are elucidated hereinunder in more detail by reference to highly simplified schematic depictions.

### BRIEF DESCRIPTION OF THE DRAWINGS

FIG. 1 shows a schematic depiction of a LIDAR device according to an example embodiment of the present invention,

FIG. 2 shows a schematic depiction of a receiving unit according to a first example embodiment of the present invention.

FIG. 3 shows a schematic depiction of a receiving unit according to a second example embodiment of the present invention.

FIG. 4 shows a schematic depiction of a receiving unit according to a third example embodiment of the present invention.

### DETAILED DESCRIPTION OF EXAMPLE EMBODIMENTS

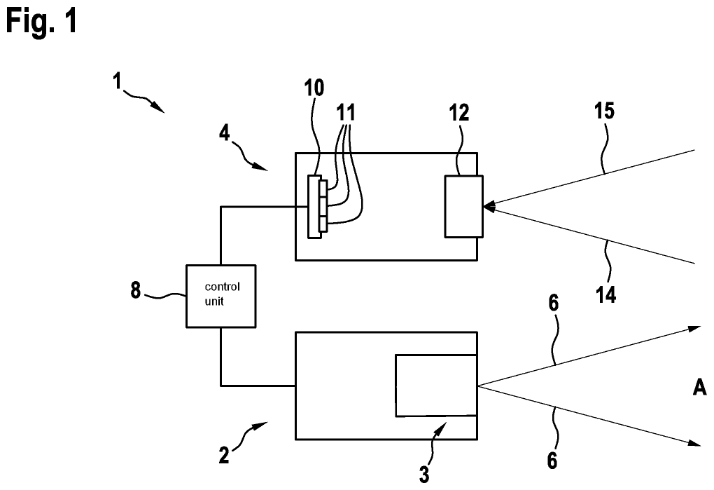

FIG. 1 shows a schematic depiction of a LIDAR device 1 according to an example embodiment of the present invention. The LIDAR device 1 includes a transmitting unit 2 and a receiving unit 4.

The transmitting unit 2 serves for generating and emitting rays 6 along a sampling region A. For example, the generated rays 6 may be configured as laser beams. For this purpose the transmitting unit 2 includes one or several laser emitters 3. The transmitting unit 2 may generate and emit the rays 6 at a defined pulse frequency. This may be coordinated and initiated by a control unit 8.

The receiving unit 4 includes a detector 10 and receiving optics 12. The rays 14, 15 reflected or backscattered from the sampling region A in the direction of the receiving unit 4 are received by the receiving optics 12 and guided into the receiving unit 4. The rays 14, 15 reflected or backscattered in the sampling region A consist here of reflected or backscattered rays 14 which were generated by the transmitting unit 2 and of rays 15 originating from spurious sources.

The detector 10 may be implemented as a planar detector, such as for example a CCD or CMOS. The detector 10 includes a light-sensitive region 11, which is able to generate electric signals in the form of measurement data from the incoming rays. The detector 10 is coupled with the control unit 8 in such a way that a location-dependent evaluation of the measurement data of the detector 10 is possible. In particular, the measurement data may be assigned to the light-sensitive regions 11 in which the respective measurement data were generated by incident rays.

The control unit 8 may preferably be implemented as an evaluation unit for evaluating the measurement data of the detector 10.

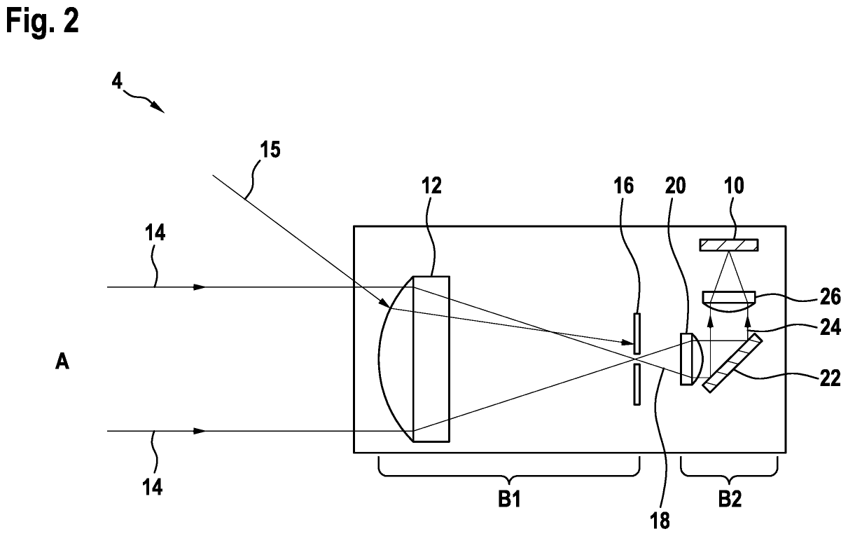

FIG. 2 shows a schematic depiction of the receiving unit 4 according to a first example embodiment. The construction of the receiving unit 4 is visualized in detail.

The receiving unit 4 includes receiving optics 12 implemented as a planoconvex lens. The receiving optics 12 is followed in the ray path of the reflected rays 14 by a directional filter 16. The directional filter 16 is configured as a diaphragm or slit diaphragm. According to the example embodiment, directional filtering of the reflected or backscattered rays 14, 15 is produced by a combination of the receiving optics 12 and the directional filter 16, since only rays 14 from a defined direction are able to pass through the directional filter 16. Rays 15 from other directions are not focused by the receiving optics 12 on the slit of the directional filter 16 and consequently are blocked.

The receiving optics 12 and the directional filter 16 form a first region B1 of the receiving unit 4. The rays 18 filtered by the directional filter 16 are subsequently directed into a second region B2 of the receiving unit 4. In the second region B2, the rays 18 are formed by a first optical unit 20. According to the example embodiment, the first optical unit 20 is configured as a planoconvex lens and focuses the filtered rays 18 onto a wavelength-selective unit 22. In particular, the filtered rays 18 are collimated by the first optical unit 20 such that they exhibit the same angle of incidence on the wavelength-selective unit 22.

The wavelength-selective unit 22 is configured as a holographic grating and exhibits a reflectivity which depends on a wavelength of the filtered rays 18. For example, rays having a short wavelength may be deflected more strongly than rays having a longer wavelength.

The rays 24 deflected by the wavelength-selective unit 22 are subsequently concentrated by a second optical unit 26 onto the detector 10. Through this step, with the help of the wavelength-dependent element 22, incident rays 18 having different wavelengths are deflected to different extents. The consequence is that after the renewed focusing with the help of the second optical unit 26, the rays 24 arrive at different places on the detector 10, depending on their wavelength.

Now by selecting the correct region 11 of the detector 10, spurious background light can be separated from the useful signal. If the wavelength of the rays 6 emitted by the transmitting unit 2 changes, this region 11 may be changed accordingly.

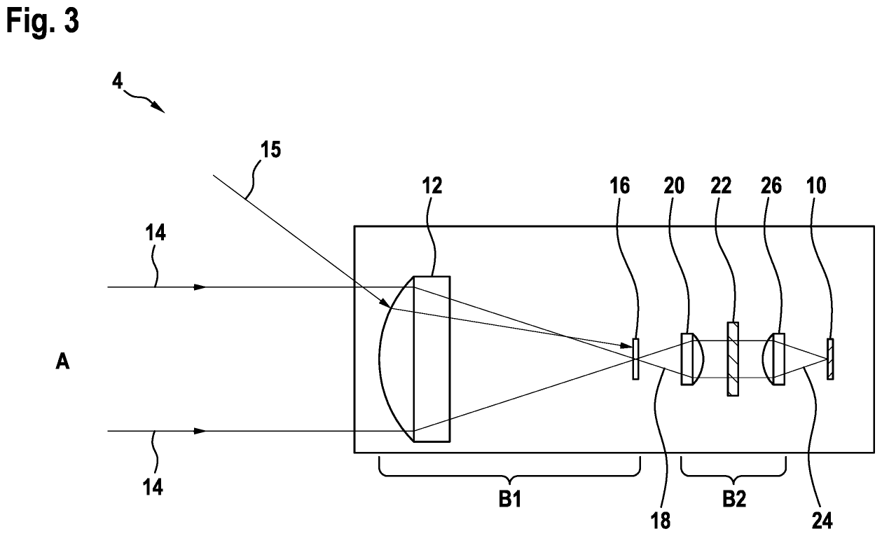

FIG. 3 shows a schematic depiction of the receiving unit 4 according to a second example embodiment. Unlike the first example embodiment, the wavelength-selective unit 22 acts on the filtered rays 18 in the passage direction. In this process, a refraction or diffraction of the filtered rays 18 takes place when transmitted through the wavelength-selective unit 22.

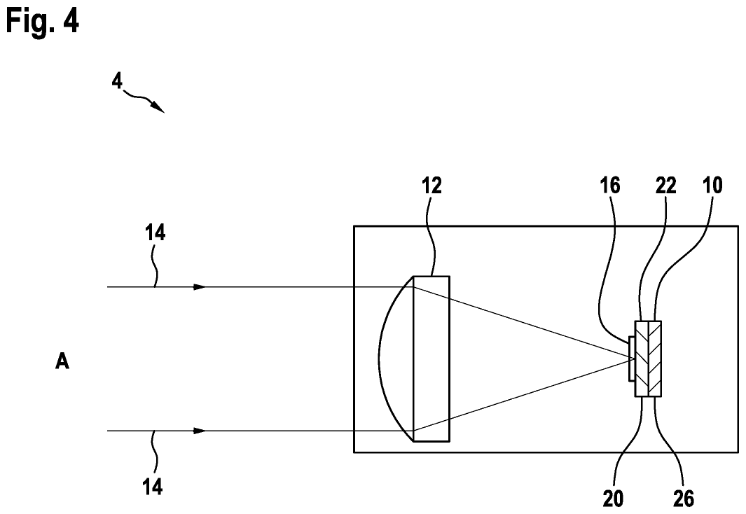

FIG. 4 illustrates a schematic depiction of the receiving unit 4 according to a third example embodiment. Unlike the above-described example embodiments, the directional filter 16, the first optical unit 20, the wavelength-selective unit 22, the second optical unit 26, and the detector 10 are implemented in one piece. For example, the components 10, 16, 20, 22, 26 are cemented with one another. The first optical unit 20 is arranged between the directional filter 16 and the wavelength-selective unit 22. The second optical unit 26 is positioned between the wavelength-selective unit 22 and the detector 10. According to the example embodiment the first optical unit 20 and the second optical unit 26 are configured as microlens arrays.

1-13. (canceled)

14. A receiving unit for a LIDAR device for receiving rays reflected and/or backscattered from a sampling region, the receiving unit comprising:
receiving optics;
at least one detector; and
a directional filter and a wavelength-selective unit arranged in a ray path of the rays between the receiving optics and the detector.

15. The receiving unit according to claim 14, wherein the directional filter is a diaphragm or a slit diaphragm.

16. The receiving unit according to claim 14, wherein the wavelength-selective unit includes transmitting or reflecting wavelength-selectivity.

17. The receiving unit according to claim 14, wherein the wavelength-selective unit is configured to adjust a wavelength-dependent angle of refraction or wavelength-dependent angle of reflection for incoming rays.

18. The receiving unit according to claim 17, wherein the rays affected by the wavelength-selective unit are guided onto the detector at a wavelength-dependent angle of refraction or at a wavelength-dependent angle of reflection, wherein measurement values ascertained by the detector from received rays are used for an evaluation as a function of their detection location on the detector.

19. The receiving unit according to claim 14, wherein the wavelength-selective unit is a diffractive optical element.

20. The receiving unit according to claim 14, further comprising:
at least one first optical arrangement arranged in a ray path between the directional filter and the wavelength-selective unit, wherein the at least one first optical element includes a lens or a cylindrical lens or a lens array, configured to collimate rays which pass the directional filter.

21. The receiving unit according to claim 20, further comprising:
at least one second optical unit arranged in a ray path between the wavelength-selective unit and the detector.

22. The receiving unit according to claim 21, wherein the second optical element is a microlens array.

23. The receiving unit according to claim 21, wherein the directional filter, the first optical element, the wavelength-selective unit, the second optical element, and the detector are implemented together in one piece or are connected integrally with one another.

24. A LIDAR device for sampling of sampling regions, comprising:
at least one transmitting unit configured to generate and radiate generated rays into a sampling region; and
at least one receiving unit for receiving rays reflected and/or backscattered from the sampling region, the receiving unit including:
receiving optics,
at least one detector, and
a directional filter and a wavelength-selective unit arranged in a ray path of the rays between the receiving optics and the detector.

25. A method for evaluating measurement data of a detector of a receiving unit, the method comprising the following steps:
receiving, by the receiving unit, rays from a sampling region;
filtering, by a directional filter of the receiving unit, the receiving rays, the filtered rays being guided directly or via at least one first optical element, onto a wavelength-selective unit;
splitting up, by the wavelength-selective unit, the filtered rays wavelength-dependently and radiating them wavelength-dependently onto different light-sensitive regions of the detector.

26. The method according to claim 25, wherein by radiating the light-sensitive regions of the detector, measurement data are generated and received by an evaluation unit, wherein at least one of the light-sensitive regions of the detector is selected in an automated or predefined manner for receiving measurement data for evaluation by the evaluation unit.
